(19) United States
(12) Patent Application Publication
(10) Pub. No.: US 2019/0255549 A1
(43) Pub. Date: Aug. 22, 2019

(54) GARDEN HOSE NOZZLE WITH TRIGGER LOCK

(71) Applicant: James A. McCommons, Daytona Beach, FL (US)

(72) Inventor: James A. McCommons, Daytona Beach, FL (US)

(21) Appl. No.: 16/280,204

(22) Filed: Feb. 20, 2019

Related U.S. Application Data
(60) Provisional application No. 62/633,833, filed on Feb. 22, 2018.

(51) Int. Cl. B05B 12/00; B05B 9/01

(52) U.S. Cl. CPC B05B 12/002; B05B 9/01

(57) ABSTRACT

This invention relates to a fluid nozzle such as a garden hose nozzle of the type having a trigger lock for the nozzle trigger handle. The garden hose nozzle will lock the trigger handle if the nozzle is accidentally dropped while in use in dispensing water to thereby prevent the accidentally squirting of water from the nozzle when the handle hits a surface. The nozzle trigger handle has a locking arm mounted through the trigger handle which is spring biased to raise the locking arm when the handle is released.

This application claims the benefit of U.S. Provisional Application No. 62/633,833, filed Feb. 22, 2018.

### FIELD OF THE INVENTION

This invention relates to a nozzle of the type having a trigger handle for controlling the flow of a fluid therefrom and especially to a nozzle of the type having a trigger handle for controlling the flow of fluid therethrough and to a nozzle having a trigger lock for the nozzle trigger handle such as a garden hose nozzle which will lock the nozzle trigger handle if the nozzle is accidentally dropped to prevent the squirting of water from the nozzle.

### BACKGROUND OF THE INVENTION

A conventional garden hose nozzle of the type having a trigger handle has a body with a handle that is squeezed with the palm of the hand holding the nozzle to actuate the flow of water from the nozzle. This type of nozzle works very well for spraying water from a garden hose. When the handle, which is biased open with the nozzle valve closed, is released, the water is shut off. However, the handle does protrude from the outside of the nozzle body and may be activated if the nozzle falls to the ground hitting the nozzle handle against a surface. The nozzle may be accidently activated by the nozzle handle hitting the ground to cause erratic discharge of water from the nozzle resulting in wetting the user and objects nearby.

The prior U.S. Pat. No. 6,575,387 to Baker is for an annular trigger lever guard for a garden hose nozzle to prevent a dropped nozzle handle from hitting the ground and accidentally spraying of the nozzle.

The Clark U.S. Pat. No. 8,225,964 is for a self-locking handheld adhesive dispenser and method of using such adhesive dispenser. It has a spring biased trigger lock mechanism to lock and unlock the trigger.

The Marchand et al. U.S. Pat. No. 7,389,949 is for a pressure washer having a trigger lock. The lock member is disposed within the interior and movable between locked and unlocked positions.

The Brown et al. U.S. Pat. No. 6,431,468 is for a safety mechanism for dispensing multiple fluids and has a safety for preventing unintended operation.

The DeWall et al. U.S. Pat. No. 7,516,910 is for a pressure washer with a trigger lock. The lock member is located within the interior of the handle and is movable between locked and an unlocked positions.

This invention is for a garden hose nozzle having a trigger lock for a garden hose nozzle trigger handle and especially to a garden hose nozzle which will lock the trigger handle if the nozzle is accidentally dropped while in use dispensing water.

### SUMMARY OF THE INVENTION

A garden hose nozzle has a trigger lock for the nozzle trigger handle. The garden hose nozzle will lock the trigger handle if the nozzle is accidentally dropped while in use in dispensing water to thereby prevent the accidentally squirting of water from the nozzle when the handle hits a surface. The nozzle trigger handle has a locking arm mounted through the trigger handle and is spring biased to raise the locking arm when the handle is released.

A fluid nozzle has a locking handle having a nozzle body having a fluid inlet at one end and a fluid outlet at the other end thereof, and a fluid passageway therebetween. The nozzle body has a hand grip portion having an elongated groove and with a locking notch therein. A valve is located in the nozzle body passageway for opening and closing the passageway to the passage of fluid which valve has a valve stem extending from the body. A trigger handle is hinged to the body, and is coupled to the valve stem for actuating the valve upon moving the trigger handle to open and close the valve to control the flow of fluid through the passageway. The trigger handle has an elongated opening therethrough. A trigger handle locking arm has two ends and an elongated opening therethrough. The locking arm extends through the trigger handle opening and is movably pinned thereto through the elongated opening therein. The locking arm has the one end slidable in the nozzle body hand grip portion elongated groove and nesting in the hand grip locking notch on the nozzle body hand grip portion. The locking arm has a spring attached between the trigger handle and the locking arm for biasing the locking arm to pull the trigger handle to a valve closed and locked position. When the trigger handle is released, the spring will slide the locking arm one end into the hand grip locking notch thereby preventing the trigger handle movement and the opening of the valve to the flow of fluid until the locking arm is manually released from the locked position. Releasing the nozzle trigger handle will lock the trigger handle against accidental actuation of the valve such as by dropping the nozzle.

### BRIEF DESCRIPTION OF THE DRAWINGS

The accompanying drawings, which are included to provide further understanding of the invention, are incorporated in and constitute a part of the specification and illustrate an embodiment of the invention and together with the description serve to explain the principles of the invention.

In the drawings:

FIG. 1 is a perspective view of a water hose nozzle in accordance with the present invention;

FIG. 2 is side elevation of the water nozzle of FIG. 1; and

FIG. 3 is a side elevation of the water nozzle of FIGS. 1 and 2 being operated with a person's hand.

### DETAILED DESCRIPTION OF EXEMPLARY EMBODIMENT

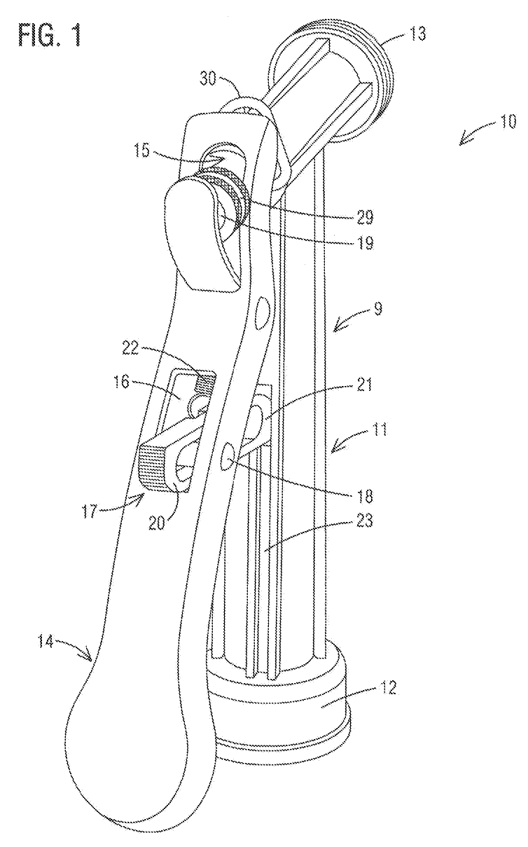

Referring to the drawings, FIGS. 1 through 3, a fluid nozzle, such as a garden hose water nozzle 10, has a body 11 having an inlet 12 which connects to a garden hose and an outlet 13 for spraying a fluid therefrom and a fluid passageway therebetween. The nozzle 10 has a handle portion 9 and a nozzle trigger handle 14 hinged to the body 11 which activates a valve 15 in the body 10 to open the nozzle to the passage of water therethrough when activated by pushing the trigger handle 14 to pull or release the stem 19 and valve 15. The valve is closed by releasing the trigger handle 14 to stop the flow of water. A knurled knob 29 may be rotated to adjust the spray pattern and spray distance.

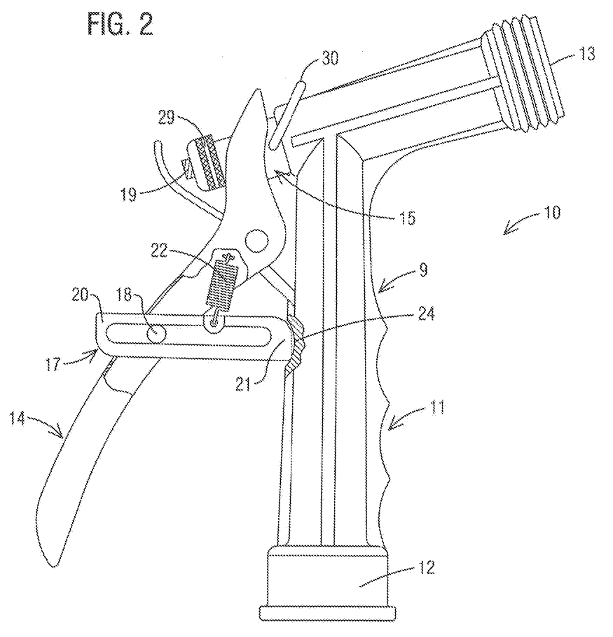

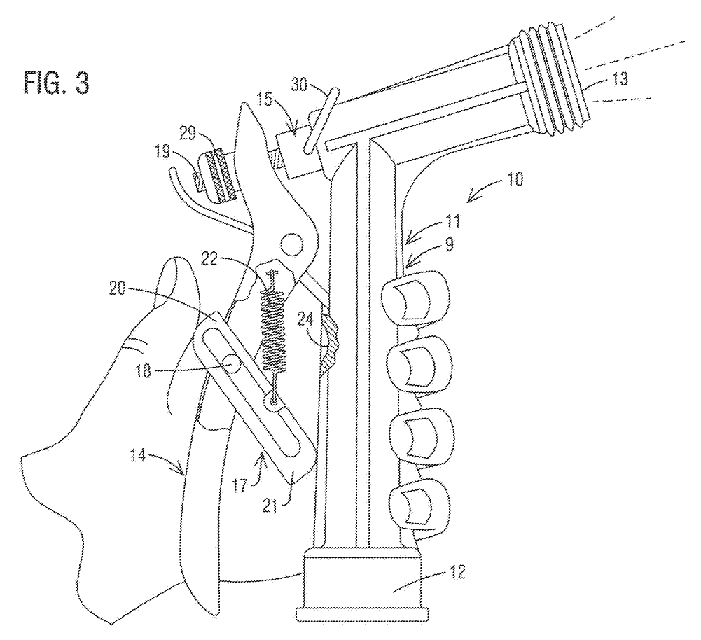

The nozzle trigger handle 14 has an opening slot 16 therethrough which has a locking arm 17, which also has an elongated slot therethrough, extending through the handle 14 and movably pinned thereto with a pin 18. The locking arm has one end 20 extending from the trigger handle 14 and a second end 21 sliding in a groove in the 23 body 11 handle portion 9 as seen in FIGS. 2 and 3. A biasing member or spring 22 is attached to the locking arm 20 at one end and to the trigger handle 14 as seen in FIG. 2 at the other end to bias the locking arm 17 in an upward direction to pull the locking arm 17 into a locking position nested in the notch 24 and blocking the trigger handle from being squeezed to open the valve 15 of the nozzle 10. The nozzle body 11 has the groove 23 formed therein for the end 21 of the locking arm 17 to slide in to make sure the locking arm 17 slides smoothly. It may also have locking arm 17 end 21 resting in a locked nested position in notch 24. The handle 14 is unlocked by a user simply moving the protruding locking arm 17 knurled end 20 with his thumb as seen in FIG. 3.

The trigger handle is easily activated by a user holding the nozzle in the palm of his hand and using his thumb as shown in FIG. 3 to release the locking arm 17 by pressing against the end 20 of the protruding locking arm and squeezing the trigger handle to activate the nozzle valve 15. This allows the locking arm 17 to slide downward in the groove 23 while extending the spring 22 as seen in FIG. 3. If the handle 14 is released, the spring 22 will pull the locking arm 17 upwards which will return the handle 14 to its locked position with the end 21 of the locking arm 17 nested in the notch 24. If the nozzle 10 is accidently dropped and the nozzle trigger handle released the nozzle trigger handle 14 will automatically retract and the spring 22 will pull the locking arm 20 and trigger handle 14 to shut off the flow of water. In the present invention, a dropped nozzle will cause the locking arm 17 to be biased into a locking position by the spring 22 to prevent the trigger handle 14 from being actuated upon being dropped. A manual trigger handle lock 30 may also be provided as desired.

It should be clear at this time that a garden hose nozzle with a spring biased locking arm to prevent the accidentally squirting of water when the nozzle is dropped has been provided. However the present invention is not to be considered as limited to the forms shown which are to be considered illustrative rather than restrictive.

I claim:

1. A fluid nozzle having a locking handle comprising:
a nozzle body having a fluid inlet at one end and a fluid outlet at the other end thereof, and a fluid passageway therebetween, said body having a hand grip portion;
a valve positioned in said nozzle body passageway for opening and closing said passageway to the passage of fluid, said valve having a valve stem extending from said body;
a trigger handle hinged to said body, said trigger handle being coupled to said valve stem for actuating said valve upon moving of said trigger handle to open and close said valve to control the flow of fluid through said passageway, said trigger handle having an opening therethrough;
a trigger handle locking arm having two ends and an elongated opening therethrough, said locking arm extending through said trigger handle opening and being movably pinned thereto through said elongated opening therein, said locking arm having one end slidable on said nozzle body hand grip portion into a hand grip lock on said nozzle body hand grip portion and said locking arm having a spring biasing said locking arm and attached trigger handle to close said valve when said trigger handle is released and to slide said locking arm one end into said locking arm hand grip lock to prevent trigger handle movement and the opening of said valve to the flow of fluid until said locking arm is manually released from said locked position;
whereby releasing said nozzle trigger handle will lock said trigger handle against accidental actuation of said nozzle valve.

2. The fluid nozzle in accordance with claim 1 in which said locking arm spring is attached between said trigger handle and said locking arm for biasing said locking arm to pull said trigger handle to a valve closed position.

3. The fluid nozzle in accordance with claim 2 in which said locking arm spring is a coiled spring.

4. The fluid nozzle in accordance with claim 1 in which said nozzle body hand grip portion has a groove on its surface for said locking arm one end to slide in.

5. The fluid nozzle in accordance with claim 4 in which the nozzle body hand grip portion lock is a notch for said locking arm one end to nest in when in a nozzle valve locked position.

6. The fluid nozzle in accordance with claim 1 in which said locking arm elongated slot allows the locking arm to slide and rotate on said trigger handle.

7. The fluid nozzle in accordance with claim 1 in which the locking arm other end protrudes through said trigger handle and is positioned for releasing said locking arm from a locked position.

8. The fluid nozzle in accordance with claim 6 in which the locking arm other end is knurled.

9. The fluid nozzle in accordance with claim 1 in which said trigger handle opening is an elongated opening.

10. A fluid nozzle having a locking handle comprising:
a nozzle body having a fluid inlet at one end and a fluid outlet at the other end thereof, and a fluid passageway therebetween, said body having a hand grip portion having an elongated groove and a locking notch formed therein;
a valve positioned in said nozzle body passageway for opening and closing said passageway to the passage of fluid, said valve having a valve stem extending from said body;
a trigger handle hinged to said body, said trigger handle being coupled to said valve stem for actuating said valve upon moving of said trigger handle to open and close said valve to control the flow of fluid through said passageway, said trigger handle having an elongated opening therethrough;
a trigger handle locking arm having two ends and an elongated opening therethrough, said locking arm extending through said trigger handle elongated opening and being movably pinned thereto through said elongated opening in said locking arm, said locking arm having one end slidable in said nozzle body hand grip portion elongated groove and to nest in said notch to lock said trigger handle locking arm and trigger handle in a closed valve position and said locking arm having a spring attached between said trigger handle and said locking arm for biasing said locking arm to pull said locking arm one end into a nesting position in said notch to lock said trigger handle in a valve closed position and lock said locking arm and trigger handle in a valve closed position to prevent said trigger handle movement and the opening of said valve to the flow of fluid until said locking arm is manually released from said locked position;
whereby releasing said nozzle trigger handle will lock said trigger handle against accidental actuation of said nozzle valve.
